(19) United States
(12) Patent Application Publication
(10) Pub. No.: US 2010/0070467 A1
(43) Pub. Date: Mar. 18, 2010

(54) DATABASE MANAGEMENT COMPUTER PRODUCT

(75) Inventors: Hiroyuki TAKAKUWA, Yokohama (JP); Yuuji ISHIDA, Bunkyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/567,027

(22) Filed: Sep. 25, 2009

Related U.S. Application Data
(63) Continuation of application No. PCT/JP2007/056896, filed on Mar. 29, 2007.

(51) Int. Cl. G06F 17/30

(52) U.S. Cl. 707/609; 707/E17.005

(57) ABSTRACT

A computer-readable recording medium stores therein a database managing program that causes a computer having access to a database to execute acquiring, for each regular section of the database, a count of unfinished transactions having a given process unfinished; determining, based on the count of unfinished transactions acquired at the acquiring and among the regular sections, sections that are to be reorganized; judging, for each transaction stored in the sections determined to be reorganized at the determining, whether the transaction is an unfinished transaction; and storing to a reserve section of the database, a transaction judged to be an unfinished transaction at the judging and storing to a recording medium different from the database, a transaction judged not to be an unfinished transaction at the judging.

### FIELD

The embodiments discussed herein are related to database management.

### BACKGROUND

Conventionally, since a database accumulating transactions generated as needed is limited in capacity, memory is made available by periodically saving transactions after a given process is finished (finished transactions) to a recording medium such as magnetic tape (MT).

However, if only the finished transactions are simply saved, available areas on a database have a worm-eaten state. If processing for writing to the database is executed when a database in such a state, a problem of a deteriorated processing efficiency occurs.

Thus, a technology has been devised that enables available areas to be reutilized in block units by managing the database in block units and aggregating available areas in successive blocks. It is considered that such a technology may be utilized to improve efficiency when writing to a database (see e.g., Japanese Laid-Open Patent Publication No. H8-263339).

Although actual data is aggregated as a result of the aggregation of available areas in the conventional technology disclosed in Japanese Laid-Open Patent Publication No. H8-263339, the aggregation is performed indiscriminately, for example, even if data not likely to be subject to subsequent online processing (i.e., unnecessary data) is included in the actual data. Hence, the available area may not be increased efficiently. To ensure consistency of the database, online processing is terminated when available areas are aggregated and it is problematic that the conventional technology is not applicable to online systems such as a web shopping system for which operation is desirable 24 hours a day.

### SUMMARY

According to an aspect of an embodiment, a computer-readable recording medium stores therein a database managing program that causes a computer having access to a database to execute acquiring, for each regular section of the database, a count of unfinished transactions having a given process unfinished; determining, based on the count of unfinished transactions acquired at the acquiring and among the regular sections, sections that are to be reorganized; judging, for each transaction stored in the sections determined to be reorganized at the determining, whether the transaction is an unfinished transaction; and storing to a reserve section of the database, a transaction judged to be an unfinished transaction at the judging and storing to a recording medium different from the database, a transaction judged not to be an unfinished transaction at the judging.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of a system configuration of a web shopping system according to an embodiment of the present invention;

FIG. 2 is an explanatory diagram of a configuration of an order database;

FIG. 3 is an explanatory diagram of a data configuration of each section formed in the order database;

FIG. 4 is an explanatory diagram of a data configuration of a transaction stored in the order database;

FIG. 5 is a block diagram of a server according to an embodiment;

FIG. 6 is a block diagram of a functional configuration of the server;

FIG. 7 is a flowchart of database management processing by the server;

FIG. 8 is an explanatory diagram of an example of the order database accumulating transactions;

FIG. 9 is an explanatory diagram of an example of the order database after transactions are stored to magnetic tape (MT);

FIG. 10 is an explanatory diagram of an example of the order database after sections have been changed; and

FIG. 11 is a flowchart of a transaction update process by an online program.

### DESCRIPTION OF EMBODIMENTS

Preferred embodiments of the present invention will be explained with reference to the accompanying drawings.

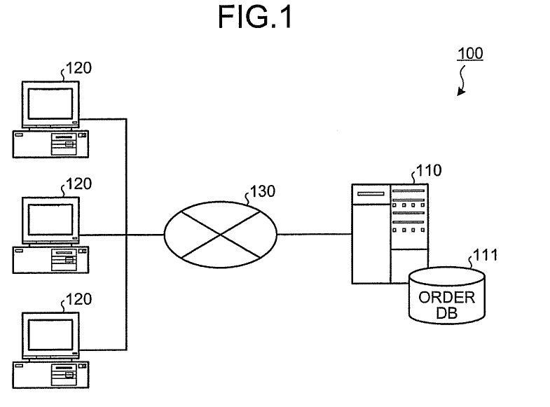

FIG. 1 is an explanatory diagram of a system configuration of a web shopping system according to an embodiment of the present invention.

A web shopping system 100 depicted in FIG. 1 is a system that enables customers to shop over the internet. The web shopping system 100 includes a server 110 and terminal apparatuses 120 utilized by customers, the terminal apparatuses 120 being communicably connected to the server 110 through a network 130.

The server 110 is an information processing apparatus that includes an online program. For example, the online program executes processes such as providing shopping information to the terminal apparatuses 120 and accumulating received order information (transactions) in an order database 111. The online program also functions as an update program and updates transactions accumulated in the order database 111 according to processing results for a series of transaction processes. The server 110 further functions as a database managing apparatus and executes database management of the order database 111. The order database 111 may be included in the server 110 or may be included in another information processing apparatus accessible from the server 110.

The terminal apparatuses 120 are web terminal apparatuses such as personal computers belonging to customers. For example, the terminal apparatuses 120 execute processes such as receiving shopping information from the server 110, displaying the received shopping information, accepting an input of order information from users, and transmitting the input order information to the server 110.

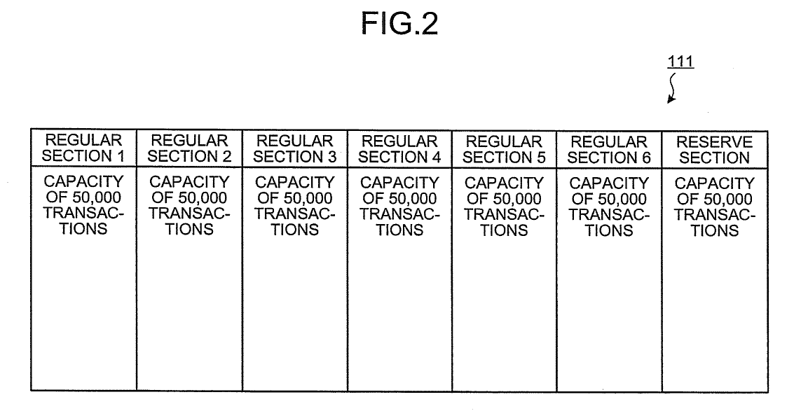

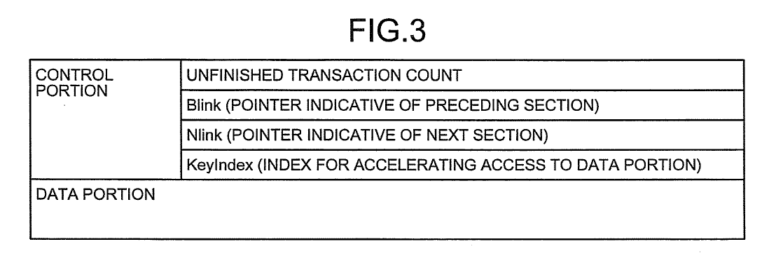

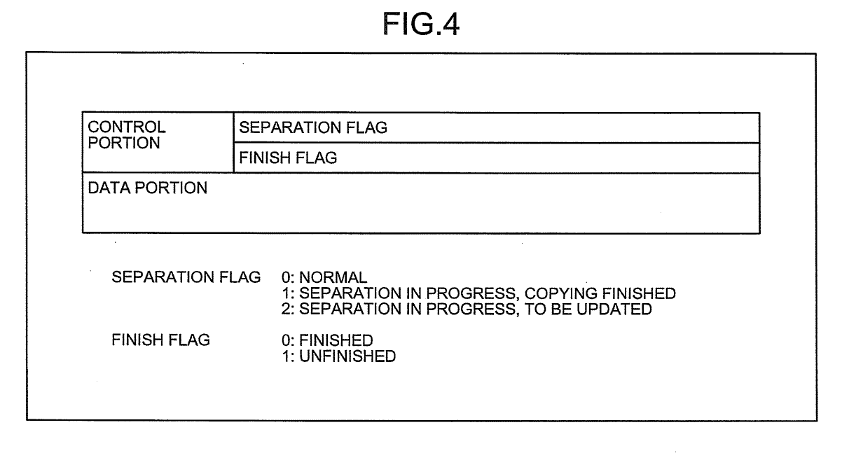

FIG. 2 is an explanatory diagram of a configuration of the order database 111. FIG. 3 is an explanatory diagram of a data configuration of each section formed in the order database 111. FIG. 4 is an explanatory diagram of a data configuration of a transaction stored in the order database 111.

As depicted in FIG. 2, for example, six regular sections (regular sections 1 to 6) and one reserve section are formed in the order database 111 and each section is able to store 50,000 transactions. The regular sections are sections allowing access to the transactions from the online program. In this embodiment, the total capacity of the six regular sections is assumed to accommodate 300,000 transactions and this capacity corresponds to transactions for 30 days, assuming 10,000 transactions per day. The number of sections and capacity of each section are not limited hereto and may be adjusted based on the amount of transactions per day obtained from past analytical data, etc., or the number of effective days of transactions (the number of days for which transactions are to be stored in the order database 111). The sections may be logical or physical sections.

Although not depicted, the order database 111 is provided with a pointer for identifying a head section, a pointer for identifying a tail section, and a pointer for identifying a section in which a transaction is stored last. This configuration enables easy identification of a transaction search start position, a transaction addition position, and a linking position of available sections.

Each of the sections formed in the order database 111 includes a “control portion” that stores control data and a “data portion” that stores actual data. The “control portion” includes items of “unfinished transaction count”, “Blink”, “NLink”, and “KeyIndex”.

In the “unfinished transaction count” item, the number of unfinished transactions (i.e., transactions with “0” set for a “finish flag” item) among the transactions stored in a given section is set. An “unfinished transaction” means a transaction having a given process that has not been completed among a series of transaction processes, such as giving delivery instructions to a warehouse, making a delivery request to a delivery service company, confirming payment, and elapse of the cooling-off period, and a “finished transaction” has the opposite meaning.

In the “Blink” item, a pointer is set that identifies a section preceding the given section. In the “Nlink” item, a pointer is set that identifies a section subsequent to the given section. Although not essential, in the “KeyIndex” item, an index for accelerating access is set.

A transaction stored in the order database 111 includes a “control portion” that stores control data and a “data portion” that stores actual data as depicted in FIG. 4. The “control portion” includes items of “separation flag” and “finish flag”.

In the “separation flag” item, identification information is set that indicates whether the given transaction is stored in the reserve section. For example, if the given transaction is not stored in the reserve section, the “separation flag” item is set to “0”.

If the given transaction is stored in the reserve section, the “separation flag” item is set to “1”. Therefore, for example, if a transaction with the “separation flag” item set to “1” is updated among transactions stored in the regular sections, the online program registering/referencing/updating the transactions in the order database 111 is able to determine that update data is to be generated for updating the transaction stored (copied) to the reserve section.

If a transaction is stored in the reserve section and the update data for the transaction exists, the “separation flag” item is set to “2”. Therefore, for example, if a transaction with the “separation flag” item set to “2” is updated among transactions stored in the regular sections, the online program registering/referencing/updating the transactions in the order database 111 is able to determine that the generated update data is to be updated.

On the other hand, in the “finish flag” item, identification information is set that indicates whether a given transaction is an unfinished transaction. For example, in this embodiment, the “finish flag” item is set to “0” in the case of a “finished transaction” and to “1” in the case of an “unfinished transaction”.

For example, in the case of a newly registered transaction, the “separation flag” item is set to “0” and the “finish flag” item is set to “1”. Subsequently, information is referenced/updated/added in a series of transaction processes and the “finish flag” item is set to “0” after completion of the series of transaction processes.

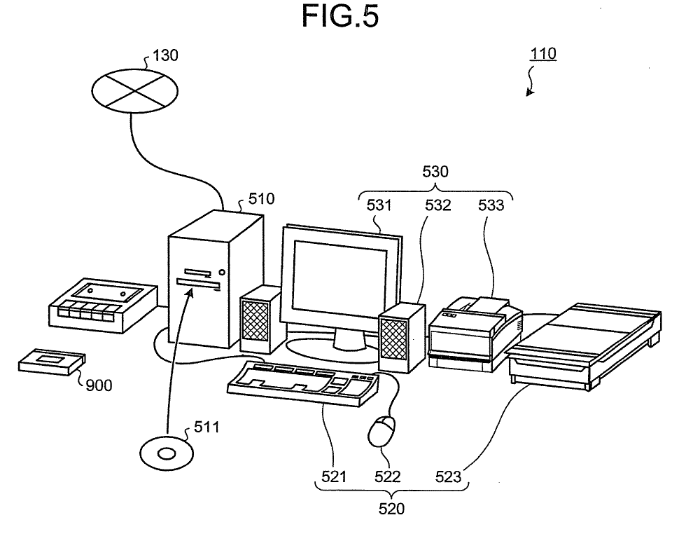

FIG. 5 is a block diagram of the server according to an embodiment.

As depicted in FIG. 5, the server 110 includes a computer 510, input apparatus 520, and output apparatus 530, and may be connected to a network 130, such as a local area network (LAN), a wide area network (WAN), or the Internet through a non-depicted router or a modem.

The computer 510 has a central processing unit (CPU), a memory, and an interface. The CPU governs overall control of the server 110. The memory is formed of, for example, read-only memory (ROM), a random access memory (RAM), a hard disk (HD), an optical disk 511, a flash memory, and MT 900. The memory is used as a work area of the CPU.

Various programs are stored in the memory and loaded in response to a command from the CPU. The reading and the writing of data with respect to the HD, the optical disk 511, and the MT 900 are controlled by a disk drive. The optical disk 511, the flash memory, and the MT 900 are removable from the computer 510. The interface controls input from the input apparatus 520, output to the output apparatus 530, and transmission/reception with respect to the network 130.

As the input apparatus 520, a keyboard 521, a mouse 522, and a scanner 523 are adopted. The keyboard 521 includes keys to input, for example, characters, numeric figures, and various kinds of instructions, and data is input through the keyboard 521. The keyboard 521 may be a touch panel. The mouse 522 is used to move a cursor, select a range, move a window, or change window size. The scanner 523 optically reads an image as image data, which is stored in the memory of the computer 510. The scanner 523 may have an optical character recognition (OCR) function.

As the output apparatus 530, a display 531, a speaker 532, a printer 533, etc. are adopted. The display 531 displays a cursor, an icon, or a tool box as well as data, such as text, an image, and function information. The speaker 132 outputs sound, such as a sound effect or a text-to-voice converted sound. The printer 533 prints image data and text data.

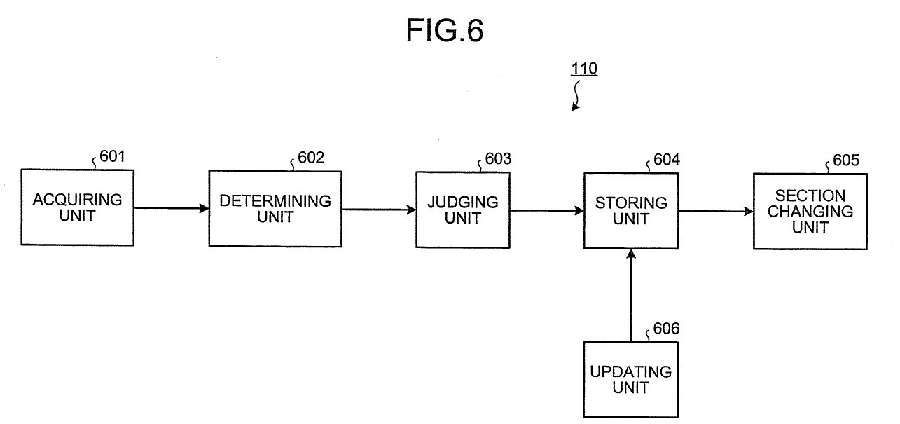

FIG. 6 is a block diagram of a functional configuration of the server 110 according to the embodiment.

As depicted in FIG. 6, the server 110 includes an acquiring unit 601, a determining unit 602, a judging unit 603, a storing unit 604, a section changing unit 605, and an updating unit 606.

The acquiring unit 601 acquires the unfinished transaction count for each of the regular sections formed in the order database 111. Although in the present embodiment, as depicted in FIG. 3, configuration is such that the unfinished transaction count is kept in each of the sections and acquired, configuration is not limited hereto and configuration may be such that the unfinished transaction count is acquired for each of the sections using another method.

The determining unit 602, from among the regular sections formed in the order database 111, determines the regular sections that are to be reorganized, based on the unfinished transaction count acquired by the acquiring unit 601. Specifically, if the total of the transaction counts of two successive regular sections is smaller than a predetermined number (in this embodiment, the number of transactions storable in one section), the two successive regular sections are the sections to be reorganized. Although the regular sections that are to be reorganized are two successive regular sections in this embodiment, configuration is not limited hereto and three or more successive regular sections may be used.

The judging unit 603, with respect to each transaction stored in the regular sections determined as the sections to be reorganized by the determining unit 602, judges whether a transaction is an unfinished transaction. Although, as depicted in FIG. 4, configuration is such that each transaction has a finish flag, which is used to judge whether the transaction is an unfinished transaction in this embodiment, configuration is not limited hereto and another method may be used to determine whether a transaction is an unfinished transaction.

For transactions judged as unfinished transactions by the judging unit 603, the storing unit 604 copies the data and stores the copied data into the reserve section formed in the order database 111 and, for the transactions not judged as unfinished transactions by the judging unit 603, the storing unit 604 stores the copied data to a recording medium other than the order database 111. Although MT is used as an example of a recording medium, configuration is not limited hereto.

The section changing unit 605 changes the reserve section having the unfinished transactions stored thereto by the storing unit 604 to the regular section and initializes both of the regular sections determined by the determining unit 602 as sections to be reorganized and changes one of the sections to a reserve section. The section changing unit 605 changes the sections such that the reserve section changed to the regular section is a head section of the regular sections. The section changing unit 605 also changes the sections such that the other of the initialized regular sections (the regular section not changed to the reserve section) is a tail section of the regular sections. The above changes with respect to the sections are implemented by changing the values set in the “Blink” item and the “NLink” item of the sections.

The updating unit 606 acquires update data from the online program for the unfinished transactions stored in the reserve section and uses the acquired update data to update the unfinished transactions stored in the reserve section. For example, the update data from the online program is stored in a work area, such as a memory. The updating unit 606 refers to the work area and determines whether update data exists. If it is determined that the update data exists, the update data is acquired from the work area and used to update the unfinished transactions stored in the reserve section.

When updating the unfinished transactions stored in the reserve section, the updating unit 606 prohibits access to the order database 111 from the online program. After updating the unfinished transactions stored in the reserve section, the updating unit 606 allows access to the order database 111 from the online program.

Specifically, functions of the above functional constituent units are implemented by the CPU executing a program stored in the memory included in the computer 510 depicted in FIG. 5, for example. For example, functions of the acquiring unit 601, the storing unit 604, the section changing unit 605, and the updating unit 606 are implemented by control executed by the above program with respect to the interface included in the computer 510 depicted in FIG. 5.

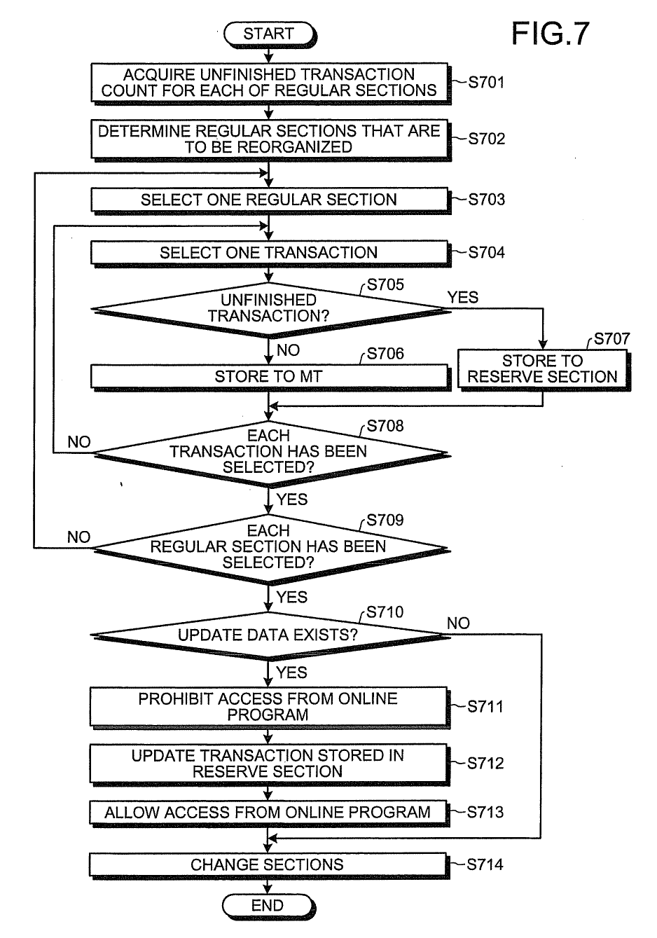

FIG. 7 is a flowchart of database management processing by the server 110.

The acquiring unit 601 acquires the unfinished transaction count for each of the regular sections formed in the order database 111 (step S701), and the determining unit 602, based on the unfinished transaction count acquired at step S701 and from among the regular sections formed in the order database 111, determines the regular sections that are to be reorganized (step S702).

Subsequently, the judging unit 603 selects one of the regular sections determined at step S702 to be a section to be reorganized (step S703), further selects one transaction from the regular section selected at step S703 (step S704), and judges whether the transaction selected at step S704 is an unfinished transaction (step S705).

If it is judged that the transaction is not an unfinished transaction at step S705 (step S705: NO), the storing unit 604 stores this transaction to the MT (step S706) and the process proceeds to step S708. On the other hand, if it is judged that the transaction is an unfinished transaction at step S705 (step S705: YES), the transaction is stored to the reserve section (step S707) and the process proceeds to step S708. The storing unit 604 sets “1” for the “separation flag” item of the transaction to be stored in the reserve section. The storing unit 604 newly sets the “unfinished transaction count” item in the reserve section to a value obtained by adding “1” to the value set in the “unfinished transaction count” item of the reserve section.

It is then judged whether each of the transactions has been selected from the regular section selected at step S703 (step S708). If it is judged that each of the transactions has not been selected at step S708 (step S708: NO), the process returns to step S704. On the other hand, if it is judged that each of the transactions has been selected at step S708 (step S708: YES), it is judged whether each of the regular sections determined as the sections to be reorganized have been selected (step S709).

If it is judged that each of the regular sections has not been selected at step S709 (step S709: NO), the process returns to step S703. On the other hand, if it is judged that each of the regular sections has been selected at step S709 (step S709: YES), the updating unit 606 judges whether update data exists in the work area (step S710).

If it is judged that no update data exists in the work area at step S710 (step S710: NO), the section changing unit 605 changes the sections (step S714), terminating a series of the processing.

On the other hand, if it is judged that update data exists in the work area at step S710 (step S710: YES), the updating unit 606 prohibits access to the order database 111 from the online program (step S711).

The updating unit 606 uses the update data in the work area to update the transaction stored in the reserve section (step S712). The updating unit 606 sets “0” for the “separation flag” item of the transaction to be updated. Therefore, if any transactions have been updated as a finished transaction, the updating unit 606 sets the “unfinished transaction count” item in the reserve section to a value obtained by subtracting the number of the transactions updated as finished transactions from the value set in the “unfinished transaction count” item of the reserve section.

The updating unit 606 allows access to the order database 111 from the online program (step S713). The section changing unit 605 then changes the sections (step S714), terminating a series of the processing.

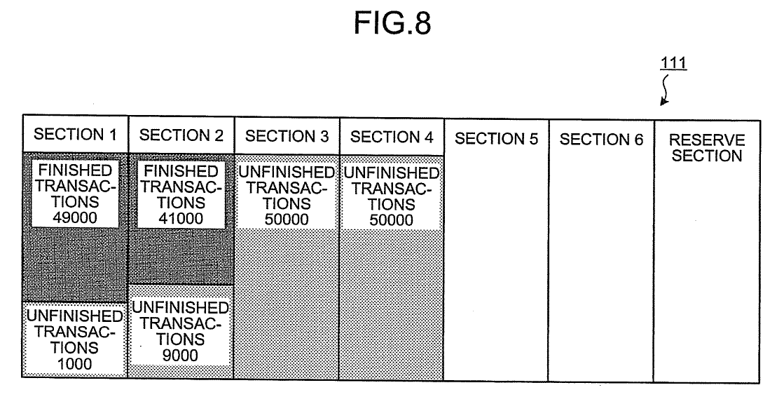

FIG. 8 is an explanatory diagram of an example of the order database 111 accumulating transactions.

The order database 111 depicted in FIG. 8 stores 50,000 transactions in each of the sections 1 to 4. Among the transactions, there are 49,000 finished transactions in the section 1 and 41,000 finished transactions in the section 2. Although available capacity may be increased by erasing the 90,000 finished transactions, the transactions may not simply be cleared in order to deal with complaints from customers and trouble that may arise.

Therefore, the two contradictory conditions may be satisfied at the same time by moving the 90,000 finished transactions to the MT (magnetic tape). However, if the finished transactions are simply moved to the MT (magnetic tape), the available areas in the order database 111 exhibit a worm-eaten state. Therefore, the order database 111 must be reorganized such that the available areas form a continuous area after the finished transactions are moved to the MT.

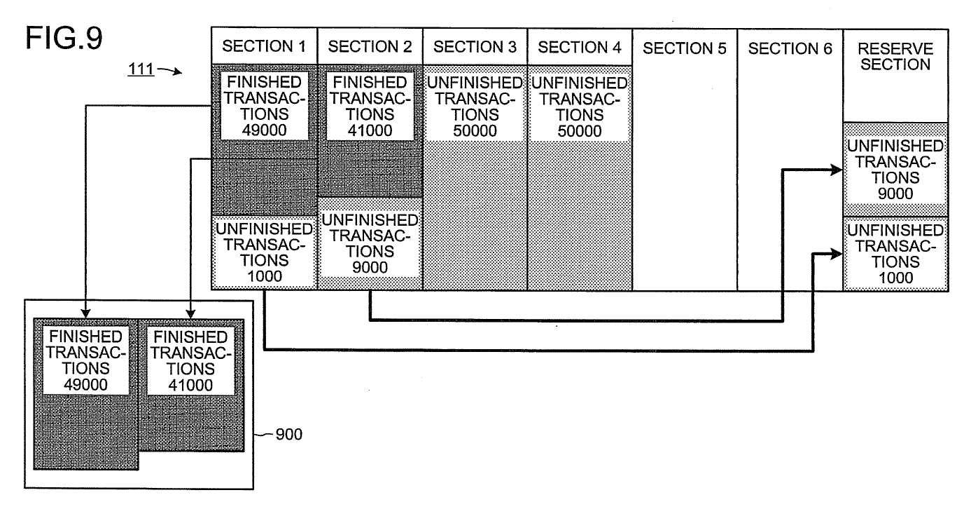

FIG. 9 is an explanatory diagram of an example of the order database 111 after the transactions are stored to the MT.

As depicted in FIG. 9, from the order database 111, which is in the state depicted in FIG. 8, the 90,000 finished transactions stored in the sections 1 and 2 that are to be reorganized are copied to the MT 900 according to the database management processing the procedure described with reference to FIG. 7. Concurrently, the 10,000 unfinished transactions stored in the sections 1 and 2 are copied to the reserve section.

At this time, the 90,000 finished transactions and the 10,000 unfinished transactions stored in the sections 1 and 2 remain stored to allow the online program to access the transactions stored in the sections 1 and 2. If the unfinished transactions stored in the sections 1 and 2 are updated, in the same way as described, the online program stores to the work area, the update data for updating the copied data of the updated transactions. The update data stored to the work area is utilized in subsequent database management processing to update the copied data, thereby preventing a situation in which only the original data, which is subsequently erased, is updated without updating of the copied data.

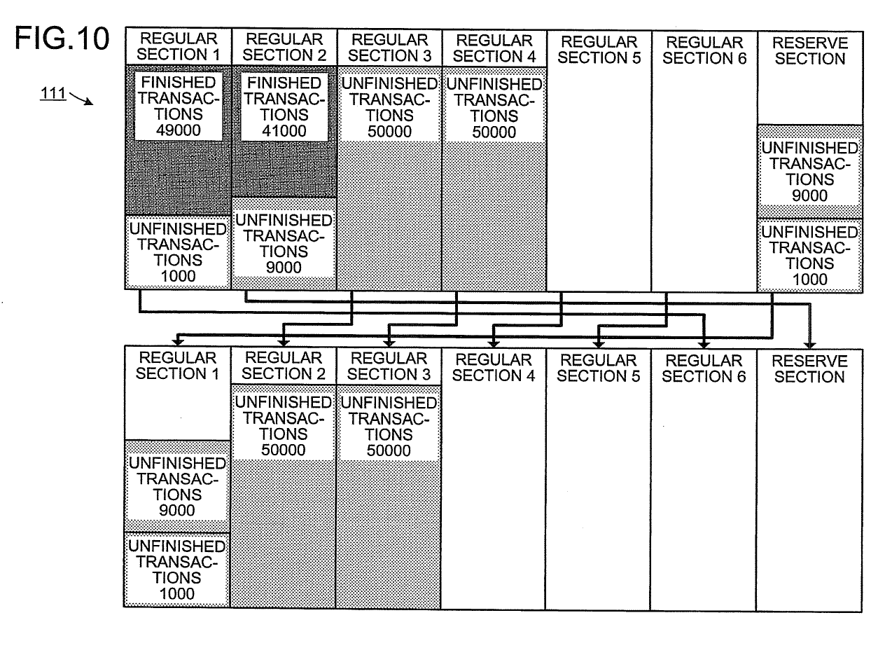

FIG. 10 is an explanatory diagram of an example of the order database 111 after the sections have been changed.

In FIG. 10, the upper portion depicts a state of the order database 111 before the sections are changed and the lower portion depicts a state of the order database 111 after the sections have been changed. As depicted in FIG. 10, first, the reserve section storing the unfinished transactions (as depicted in FIG. 9) is changed to the regular section and is placed at the head position of the regular sections. The sections 1 and 2, which are sections to be reorganized, are initialized; one of the sections is placed at the tail of the regular sections; and the other is changed to the reserve section.

If, accompanying such changes of the sections, update data from the online program is stored to the work area, the update data is used to update the unfinished transactions stored in the reserve section changed to the regular section. With the database management processing described with reference to FIG. 7, the disappearance of the update data, etc. is prevented by preliminarily prohibiting access to the order database 111 from the online program at the time of this update process.

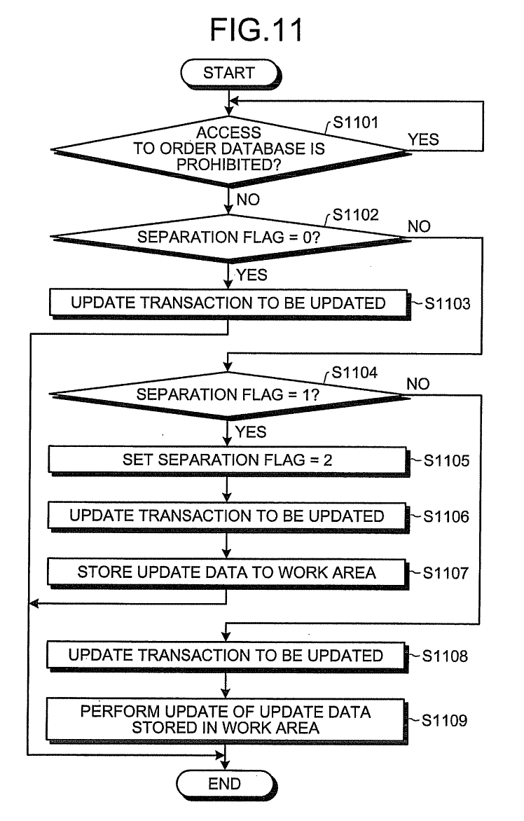

FIG. 11 is a flowchart of the transaction update process by the online program.

First, it is judged whether access to the order database 111 is prohibited (step S1101). If at step S1101, it is judged that access to the order database 111 is prohibited (step S1101: YES), step S1101 is performed repeatedly until access to the order database 111 is allowed.

On the other hand, if at step S1101, it is judged that the access to the order database 111 is not prohibited (step S1101: NO), it is judged whether the value of the “separation flag” item of the transaction to be updated is “0” (step S1102).

If at step S1102, it is judged that the value of the “separation flag” item of the transaction to be updated is “0” (step S1102: YES), the transaction to be updated is updated (step S1103), terminating a series of the processing.

On the other hand, if at step S1102, it is judged that the value of the “separation flag” item of the transaction to be updated is not “0” (step 51102: NO), it is judged whether the value of the “separation flag” item of the transaction to be updated is “1” (step S1104).

If at step S1104, it is judged that the value of the “separation flag” item of the transaction to be updated is “1” (step 51104: YES), the value of the “separation flag” item of the transaction to be updated is set to “2” (step S1105). The transaction to be updated is then updated (step 51106). The update data used for updating the transaction to be updated is stored in the work area such as a memory (step S1107), terminating a series of the processing.

On the other hand, if at step S1104, it is judged that the value of the “separation flag” item of the transaction to be updated is not “1” (step S1104: NO), the transaction to be updated is updated (step S1108). The update data already stored in the work area is updated using the update data used for updating the transaction to be updated (step S1109), terminating a series of the processing.

By updating the transactions stored in the order database 111 according to the above procedure, the online program may prevent a situation where only the transactions in the regular sections subsequently erased are updated without updating the transactions in the reserve section subsequently changed to the regular section in the order database 111.

As described, among the transactions stored in the successive regular sections, the finished transactions are aggregated in the MT and the unfinished transactions are aggregated in the reserve section. Therefore, the entire area of the successive regular sections may be made available.

The reserve section storing the unfinished transactions is changed to a regular section and at least one of the regular sections among the above successive sections is changed to the reserve section. Therefore, the reserve section storing the unfinished transactions may be reutilized as a regular section accessible from the online program. Since the reserve section may be provided newly, the database management processing may be executed repeatedly.

The update data from the online program is stored in the work area and used to update the unfinished transactions stored in the reserve section. Therefore, the online program may be operated concurrently with the database management processing and, even if the online program updates transactions before the transactions are stored to the reserve section, unfinished transactions after being stored to the reserve section may be updated.

When the unfinished transactions stored to the reserve section are updated, the online program is prohibited from accessing to the order database 111, thereby preventing a situation in the order database 111 where only unfinished transactions before storage to the reserve section are updated and unfinished transactions after storage to the reserve section are not updated.

Therefore, according to the embodiment, available areas of a database may be aggregated effectively without suspension of the online process for long periods.

The database managing method explained in the present embodiment may be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium storing therein a database managing program that causes a computer having access to a database to execute:
acquiring, for each regular section of the database, a count of unfinished transactions having a given process unfinished;
determining, based on the count of unfinished transactions acquired at the acquiring and among the regular sections, sections that are to be reorganized;
judging, for each transaction stored in the sections determined to be reorganized at the determining, whether the transaction is an unfinished transaction; and
storing to a reserve section of the database, a transaction judged to be an unfinished transaction at the judging and storing to a recording medium different from the database, a transaction judged not to be an unfinished transaction at the judging.

2. The computer-readable recording medium according to claim 1 and storing therein the database managing program that further causes the computer to execute changing the reserve section storing therein an unfinished transaction stored at the storing to a regular section and changing at least one of the sections determined to be reorganized at the determining to the reserve section.

3. The computer-readable recording medium according to claim 1 and storing therein the database managing program that further causes the computer to execute updating an unfinished transaction while the unfinished transaction is stored in the reserve section.

4. The computer-readable recording medium according to claim 3, wherein the updating includes prohibiting update of the transactions stored in the regular sections, when the unfinished transaction stored in the reserve section is updated.

5. A database managing method of a computer having access to a database, comprising:
acquiring, for each regular section of the database, a count of unfinished transactions having a given process unfinished;
determining, based on the count of unfinished transactions acquired at the acquiring and among the regular sections, sections that are to be reorganized;
judging, for each transaction stored in the sections determined to be reorganized at the determining, whether the transaction is an unfinished transaction; and
storing to a reserve section of the database, a transaction judged to be an unfinished transaction at the judging and storing to a recording medium different from the database, a transaction judged not to be an unfinished transaction at the judging.

6. The database managing method according to claim 5, further comprising changing the reserve section storing therein an unfinished transaction stored at the storing to a regular section and changing at least one of the sections determined to be reorganized at the determining to the reserve section.

7. The database managing method according to claim 5, further comprising updating an unfinished transaction while the unfinished transaction is stored in the reserve section.

8. The database managing method according to claim 7, wherein the updating includes prohibiting update of the transactions stored in the regular sections, when the unfinished transaction stored in the reserve section is updated.

9. A database managing apparatus having access to a database, comprising:
an acquiring unit that, for each regular section of the database, acquires a count of unfinished transactions having a given process unfinished;
a determining unit that, based on the count of unfinished transactions acquired by the acquiring unit and among the regular sections, determines sections that are to be reorganized;
a judging unit that, for each transaction stored in the sections determined to be reorganized by the determining unit, judges whether the transaction is an unfinished transaction; and
a storing unit that stores to a reserve section of the database, a transaction judged to be an unfinished transaction by the judging unit and that stores to a recording medium different from the database, a transaction judged not to be an unfinished transaction by the judging unit.

10. The database managing apparatus according to claim 9, further comprising a changing unit that changes the reserve section storing therein an unfinished transaction stored by the storing unit to a regular section and that changes at least one of the sections determined to be reorganized by the determining unit to the reserve section.

11. The database managing apparatus according to claim 9, further comprising an updating unit that updates an unfinished transaction while the unfinished transaction is stored in the reserve section.

12. The database managing apparatus according to claim 11, wherein the updating unit, when updating the unfinished transaction stored in the reserve section, prohibits update of the transactions stored in the regular sections.
